(19) United States
(12) Patent Application Publication
(10) Pub. No.: US 2023/0056849 A1
(43) Pub. Date: Feb. 23, 2023

(54) METHOD FOR GEOREFERENCING REMOTE SENSING DATA

(71) Applicant: FRAUNHOFER-GESELLSCHAFT ZUR FORDERUNG DER ANGEWANDTEN FORSCHUNG E.V., Munchen (DE)

(72) Inventor: Max GULDE, Freiburg (DE)

(73) Assignee: FRAUNHOFER-GESELLSCHAFT ZUR FORDERUNG DER ANGEWANDTEN FORSCHUNG E.V., Munchen (DE)

(21) Appl. No.: 17/797,482

(22) PCT Filed: Feb. 8, 2021
(86) PCT No.: PCT/EP2021/052981

§ 371 Date: Aug. 4, 2022

(30) Foreign Application Priority Data
Feb. 7, 2020 (DE) 10 2020 201 496.5

(51) Int. Cl. G01C 21/00

(52) U.S. Cl. CPC G01C 21/3852

(57) ABSTRACT

The invention relates to a method for georeferencing remote sensing data of a remote sensing platform. According to the invention, a remote sensing dataset is received by the received sensing platform, which maps a visual range of the ground surface, and a georeferencing of the remote sensing dataset is determined using a reference dataset with known georeferencing.

### BACKGROUND OF THE INVENTION

The invention relates to a method for georeferencing remote sensing data of a remote sensing platform. The remote sensing platform thereby records a remote sensing data set that depicts a visible range of the earth's surface and determines a georeferencing of the remote sensing data set using a reference data set with known georeferencing.

Remote sensing, e.g. from space, is an invaluable tool to quantitatively and qualitatively assess the state of our planet and enables a wide range of fundamental applications across almost all technology sectors (PWC, “Copernicus ex-ante benefits assessment Final report,” 2017; M. Craglia et al., “Digital Earth 2020: Towards the vision for the next decade,” Int. J. Digit. Earth, vol. 5, no. 1, pp. 4-21, 2012.). In comparison with ground-based technologies, the most notable advantage of Earth observation, e.g. using satellites, is that very large areas can be recorded and analyzed at short intervals.

For about a decade, aerospace in particular has been undergoing a revolution in the form of the New Space Movement, which is making access to space faster, easier and, above all, cheaper than ever before through new approaches—miniaturization, standardization and the use of commercially available components (H. Heidt, J. Puig-Suari, A. S. Moore, S. Nakasuka, and R. J. Twiggs, “CubeSat: A new Generation of Picosatellite for Education and Industry Low-Cost Space Experimentation,” AIAA/USU Conf. Small Satell., pp. 1-19, 2000; A. Toorian, K. Diaz, and S. Lee, “The CubeSat approach to space access,” IEEE Aerosp. Conf. Proc., vol. 1, no. 1, 2008).

The use of CubeSats (standardized small satellites) (A. Marinan and K. Cahoy, “From CubeSats to Constellations: Systems Design and Performance Analysis,” no. September, S. 116, 2013; C. Horch, M. Schimmerohn, and F. Schafer, “Integrating a large nanosatellite from CubeSat components—Challenges and solutions,” in 68th International Astronautical Congress (IAC), 2017; M. Swartwout, “The first one hundred CubeSats: A statistical look,” J. Small Satell., vol. 2, no. 2, pp. 213-233, 2013; R. Nugent, R. Munakata, A. Chin, R. Coelho, and J. Puig-Suari, “The CubeSat: The picosatellite standard for research and education,” Sp. 2008 Conf., no. September, pp. 1-11, 2008) in this context is a central component of the New Space Approach. These modular satellites, built in volumes of about one liter, are being used for increasingly demanding tasks (Banerdt et al., “InSight: A Discovery Mission to Explore the Interior of Mars,” in 44th Lunar and Planetary Science Conference, 2013, p. 1915; R. Staehle, D. Blaney, and H. Hemmati, “Interplanetary CubeSats: Opening the Solar System to a Broad Community at Lower Cost,” J. Small Satell. vol. 2, no. 1, pp. 161-186, 2013). Several constellations of over hundreds of such satellites already exist today for Earth observation and communications applications, and the market is expected to continue to develop rapidly in the coming years (M. Swartwout, “CubeSats and Mission Success: 2016 Update,” no. June, 2016; C. R. Boshuizen, J. Mason, P. Klupar, and S. Spanhake, “Results from the Planet Labs Flock Constellation,” 28th Annu. AIAA/USU Conf. Small Satell. pp. SSC14-I-1, 2014; Euroconsult, “Prospects for the Small Satellite Market,” 2017).

While the design of traditional satellite missions was primarily driven by the technical requirements of the devices on board, the New Space approach currently being pursued is fundamentally different. This approach attempts to realize the maximum performance of the technical devices on board within the available resources of a CubeSat. These resources are primarily limited by the available volume, the available power and, to a lesser extent, the available mass.

Satellites—large platforms, small satellites such as CubeSats, but also unmanned aerial vehicles (UAVs) and drones—have a positioning unit on board that determines their position relative to the Earth's surface and their current orientation. This is of particular interest in the field of earth observation, as the recorded data in most cases is later projected onto a map, in order to allow subsequent utilization of the same (US20060041375A1). This step of data preparation is called georeferencing and is usually carried out using a camera in the visible wavelength range. Geometric distortions can also be corrected by projection onto a structured planetary surface, possibly further supported by the use of a digital elevation model, and this information can then be transferred to the remaining detectors/sensors on board. In the case of imaging detectors, the transmission usually takes place via the exact determination of the relative orientation. If georeferencing is to be transferred from a visual sensor (determined by adjustment features against an existing georeferenced map) to a sensor in the non-visible wavelength range, the exact orientation and visual range of both devices relative to each other is accurately determined beforehand.

Not every Earth observation satellite records (remote sensing) data in the visible wavelength range. For example, there are a large number of satellites that record data in the radio spectrum (Terra SAR X, the ICEYE constellation, Radarsat-2, Sentinel-1) or in the infrared range (Sentinel-3, Landsat-7 and 8, CIRiS). What all these satellites have in common is that they have a visual payload to perform georeferencing. This may be accompanied by the following technical problems:
For synthetic aperture radar (SAR) payloads, it is generally difficult to perform correct georeferencing due to the lateral viewing direction of the instruments, since geometric distortions may increasingly occur (shadows, perspectivity or foreshortening, overlapping) (M. Esmaeilzade, J. Amini, and S. Zakeri, “Georeferencing on synthetic aperture radar imagery,” Int. Arch. Photogramm. Remote Sens. Spat. Inf. Sci.—ISPRS Arch., vol. 40, no. 1W5, pp. 179-184, 2015) and DE 10 2016 123 286 B4).
For small satellites whose main payload does not record in the visible range, an additional visible camera may mean substantially higher energy and volume requirements. This may ultimately lead to the need to use a larger satellite structure than originally planned. With costs currently around EUR 35,000-60,000 per kilogram in (low) Earth orbit, this can lead to significant additional costs in relation to the available budget for the overall mission.

In the case that the data to be referenced was recorded in a spectral range in which a strong change on a short time scale is to be assumed (often, for example, infrared (IR)), it cannot be assumed that there is map or other reference material that could be referenced against. Thus, standard methods for georeferencing cannot be employed. The following solutions are therefore conceivable:

As already indicated, as a general rule, it is attempted to enable georeferencing using simultaneously recorded data in the visible wavelength range. The aim here is to further miniaturize the cameras in order to achieve as little space as possible and the lowest possible power consumption. However, the requirements on the resolution and thus also on the accuracy of the georeferencing set a physical limit for the size of the aperture of the corresponding cameras and thus also for the minimum required volume.

In the case of using a second camera in the visual range, the relative line of sight between the primary payload and the payload used for georeferencing must also be known for proper operation. This is normally realized by appropriate maneuvers with a view into space and existing star charts, which involves an increased technical effort. This can also be done on board by observing objects that show similar features in both wavelength ranges, e.g. celestial bodies such as the sun or the moon, which stand out against the background in both the visible and the non-visible spectral range.

In the field of drones and low-flying UAVs, GPS sensors paired with inertial measurement units are also used to increase position accuracy (F. S. Leira, K. Trnka, T. I. Fossen, and T. A. Johansen, “A light-weight thermal camera payload with georeferencing capabilities for small fixed-wing UAVs,” 2015 Int. Conf. Unmanned Aircr. Syst. ICUAS 2015, pp. 485-494, 2015). But even the exact knowledge of the aircraft's position does not allow any real conclusions to be drawn about the sensor's line of sight.

### SUMMARY OF THE INVENTION

It is therefore the object of the following invention to provide a method for georeferencing remote sensing data which enables the required payload to be reduced while maintaining a high level of accuracy.

This object is attained by the method for georeferencing remote sensing data of a remote sensing platform according to the claims.

According to the invention, a method for georeferencing remote sensing data recorded by a remote sensing platform is disclosed. The remote sensing data is data that the remote sensing platform determines, for example as the results of measurements or surveys. Such measurements can, for example, depict properties of the Earth's surface or the atmosphere, so that the remote sensing data can be images of the corresponding properties. The remote sensing data thereby can be determined by the remote sensing platform, especially in a spatially resolved manner. Here, a value of the corresponding property can be assigned to each point of a spatial or areal survey area. In particular, the remote sensing data can be time-dependent data, i.e. data that can change over time and/or are time-variable. For example, data that depict properties of the atmosphere are often variable in time because the corresponding properties of the atmosphere are variable in time. Infrared data, which can depict a temperature distribution of the earth's surface or the atmosphere, for example, are also often variable in time, since they depend on solar radiation in many cases. Changes in vegetation and human behavior can also cause remote sensing data to vary over time.

The remote sensing data can advantageously be in matrix form so that it can be displayed as an image on a regular grid, for example. The intensity of each value in the matrix or each pixel in the image can then provide information about the amplitude of the physical parameter being measured, such as spectral density, energy density, etc.

According to the invention, a remote sensing data set is recorded by the remote sensing platform, which depicts a portion of the earth's surface referred to as the visual range. The remote sensing data set thereby includes remote sensing data. The visual range of the earth's surface can be considered to be that sub-portion of the earth's surface from the direction of which electromagnetic radiation enters a sensor used to determine the remote sensing data set. It should be noted that it is not mandatory that the electromagnetic waves emanate from the earth's surface itself. When surveying the atmosphere, the electromagnetic waves can also be generated above the Earth's surface. However, they still enter the sensor from the direction of a certain portion or point on the earth's surface.

According to the invention, a reference data set, the georeferencing of which is known, is also determined. The reference data set thus includes values of a property of a certain portion or point of the earth's surface, of which it is known from the direction of which point of the earth's surface they were recorded. The reference data set is determined in such a way that it depicts a portion of the earth's surface which overlaps at least partially with the visual range as defined above. The intersection between the visual range and the portion depicted by the reference data set is therefore not empty.

Advantageously, the reference data set is recorded at a short time interval from the remote sensing data. Advantageously, the reference data set is recorded at a time interval from the remote sensing data of at most 24 hours, preferably at most 12 hours, preferably at most 6 hours, preferably at most 1 hour, preferably at most 10 minutes, preferably at most 1 minute, preferably at most 10 seconds, preferably at most 5 seconds or simultaneously. In particular, the maximum time interval can be chosen so that changes in the physical data recorded by the remote sensing data set and/or the reference data set do not exceed a predefined threshold value at this interval. The threshold value can be chosen, for example, so that convergence of the process can still be expected. The threshold value can be determined, for example, by simulation or on the basis of previous measurements. The threshold value can be compared to a value determined from the corresponding data set, for example an average value of some or all pixels. Other characteristic values are also possible.

A temporal overlap of the measurements may depend on the measurement parameter to be observed. For example, when radiation densities are measured in the infrared spectral range, they often fluctuate on a relatively short time scale of a few seconds to minutes and the result can be degraded if the images to be compared are not close together in time. In the case of such a strong temporal variance, it is not possible to georeference against existing maps as would normally be assumed, because it cannot be assumed that the features present on the map will be reflected in the image captured from platform A. For this reason, for example, an infrared map of the Earth to refer to is not available.

The remote sensing data set and the reference data set can advantageously be grid data and optionally have different resolutions.

According to the invention, two adjustment steps are now carried out repeatedly. In a first adjustment step, the remote sensing data set and the reference data set are compared to each other and then, in a second adjustment step, a morphology operation is applied to the remote sensing data set or the reference data set based on the comparison. A morphology operation thereby is a depiction of the corresponding data set from an input georeferencing to an output georeferencing. Such morphology operations can be, for example, translation, rotation and/or perspective distortions of the image.

The first adjustment step and the second adjustment step are then repeated alternately until it is found in the first adjustment step in the described comparison of the remote sensing data set with the reference data set after applying the previous morphology operation as a termination condition that the remote sensing data set and the reference data set differ from each other by less than a predefined threshold. In the event of the termination condition occurring, the georeferencing of the reference data set is then set as the georeferencing of the remote sensing data set after applying the morphology transformations. In this context, the georeferencing of the reference data set is set as the georeferencing of the remote sensing data set after all previously executed morphology transformations have been applied, whereby one or more morphology transformations may have been executed. In the described second adjustment step, the morphology operation can be applied to the remote sensing data set or the reference data set or both. Therefore, when the termination condition occurs, one or both of the data sets is present in transformed manner by morphology operations. To determine the georeferencing of the remote sensing data set, it is then possible to calculate back to the actual georeferencing of the remote sensing data set with the executed morphology operations.

Thus, the invention uses a cooperative strategy that achieves very good georeferencing especially in the small satellite domain, but not exclusively in this domain, and yet does not add additional weight, volume and power to the remote sensing platform.

In this regard, the remote sensing data can be recorded in any possible spectral range, for example radar, infrared, UV or microwave measurements. Geometric distortions of the sensor, which can be caused by optics, are usually known and can already be taken into account. Particularly advantageously, the invention is applicable to spectral ranges in which the observed parameter is variable, for example in the infrared range. In an advantageous embodiment of the invention, the remote sensing data is recorded in the infrared range. These data are often available as grid data. An advantageous embodiment of the invention enables the georeferencing of remote sensing data, which is available as grid data, with a reference data set, which is also available as grid data. Grid data means data that is available as data recorded pixel-by-pixel. So here, each pixel includes at least one value of at least one physical parameter represented by the data set. For example, a temperature data set could include a temperature value in each pixel.

Advantageously, the reference data set includes remote sensing data in the same spectral range as the remote sensing data set, which have already been successfully georeferenced. Due to the existence of large national Earth observation programs such as the EU (Copernicus) or the USGS (Landsat Data Continuity Mission), such data are routinely freely available. If no information is available in the same spectral range, i.e. the recorded spectral range of platform A and reference platform do not overlap, different approaches can be taken to interpolate the missing spectral information [see Houborg, R., & McCabe, M. F. (2018). A Cubesat enabled Spatio-Temporal Enhancement Method (CESTEM) utilizing Planet, Landsat and MODIS data. Remote Sensing of Environment, 209(February), 211-226. https://doi.org/10.1016/j.rse.2018.02.067 and references included therein.]

Furthermore, a special feature of data sets in the long-wave spectral range, such as infrared, is the fact that they are usually much lower-resolution data than in the visible range due to the long wavelength. While resolutions of better than one meter can be achieved in the visible range, the highest resolution available in the civilian sector (i.e. the size of a pixel projected onto the ground in the Nadir direction) of thermal infrared data from satellite platforms is currently 60 meters. With this coarse resolution, it is evident that it cannot be assumed that individual features such as street intersections, chimneys, or other objects can be referenced against each other. Due to the small amount of pixels to be expected in the long-wave spectral range, it is therefore preferable to reference at pixel level.

In an advantageous embodiment of the invention, a spatial resolution of the remote sensing data set and a spatial resolution of the reference data set can be brought into correspondence for comparison in the described first adjustment step. The spatial resolution thereby can be regarded as the number of pixels for which measurement data are available per area element on the earth's surface.

It is particularly advantageous in this regard to reduce the resolution of the one of the remote sensing data set and the reference data set that has the higher resolution to the resolution of the other data set. So if the remote sensing data set has the higher resolution, its resolution can be reduced to the resolution of the reference data set. If, on the other hand, the reference data set has the higher resolution, its resolution can be reduced to the resolution of the remote sensing data set. It should be noted, however, that this is not mandatory. It is also possible to increase the resolution if additional information is integrated for this purpose.

Advantageously, the resolutions are brought into correspondence with reference to the same reference system. For this purpose, the data sets can be adjusted so that all pixel edges have the same georeferenced position. All edges of pixels of the data set with the lower resolution are advantageously located on edges of pixels of the data set with the higher resolution with the same georeferenced position.

Advantageously, the remote sensing data set and the reference data set can be values of at least one measurement parameter, wherein the values are given in pixels. A difference data set can then be created from the remote sensing data set and the reference data set for comparison in the first adjustment step described. The difference data set thereby can have a number of pixels equal to a number of pixels of the data set with the lower resolution or a number of pixels equal to that of the data set with the reduced resolution. If both data sets have the same resolution, for example because the resolutions have been adjusted to each other, the difference data set has a number of pixels equal to the number of pixels of one of the data sets.

In the following, i is intended to indicate the positions of pixels of the difference data set. The positions of the pixels of the difference data set can therefore be counted with i. In an advantageous embodiment, for all positions i of pixels of the reference data set, that pixel with position i of the difference data set may have as its value the difference between the value of the pixel of the remote sensing data set with the same position (which may also be referred to as i) and the value of the pixel of the reference data set with the same position (which may also be referred to as i).

As described, it can be used as a termination condition for the adjustment steps that the remote sensing data set and the reference data set differ from each other by less than a predefined threshold. In an advantageous embodiment of the invention, the threshold may be a threshold value which is compared to a value calculated from the values of the pixels of the remote sensing data set and the reference data set. In principle, there are many ways to define such a value, which is compared to the threshold value. A value, which is calculated as Diff=√(Σ_ᵢ(I_{A,i}−I_{Ref,i})²), is particularly advantageous, wherein I_{A,i} is the value of the pixel at position i of the remote sensing data set and I_{Ref,i} is the value of the pixel at position i of the reference data set.

In an advantageous embodiment of the invention, a calibration of the remote sensing data set and a calibration of the reference data set can be adapted to each other prior to the first adjustment step. This makes it possible to increase the accuracy of the comparison. It should be noted, however, that calibration is not mandatory, since most minimization methods that can be used for adaption allow minimization even if the compared values are shifted against each other.

In an advantageous embodiment of the invention, a preliminary georeferencing of the remote sensing platform may be estimated to determine the reference data set. This allows a reference data set to be determined more quickly and that overlaps with the portion observed by the remote sensing platform. An estimate can be made, for example, using positioning data on board, such as GPS or an Attitude Determination System (ADS), using the earth's magnetic field or by means of a star camera. A possible concrete approach to this can be, for example, the use of orbital element data of the satellite, which is normally available in the form of two-line elements (TLE). An appropriate propagation software based on the SGB4 propagator used for TLEs can be employed here. The orbital element data can be derived from the satellite's orbit as recorded by GPS and ground measurements and allows a relatively accurate determination of the position up to about two weeks into the future (a rule of thumb here is about one second deviation every 48 hours). Propagation software can be various software solutions or libraries, including for example Skyfield, which is open source and written in Python, AGI's STK, Orekit, which is written in Java and is open source. If the orientation of the remote sensing platform is then known, for example by the ADS (without a star camera normally to 1° per axis, with a star camera to 0.01° per axis), a rough estimate of the georeferencing can thereby be made.

The method according to the invention is based on a adjustment method with the described first and second adjustment steps. These adjustment steps can advantageously be carried out in a targeted manner to achieve a step-by-step optimization. Various algorithms are available that support such stepwise optimization as a function of several variables, for example translation in two dimensions, rotation, distortion, etc. An appropriate method is, for example, the Nelder-Mead Simplex method (J. C. Lagarias, J. A. Reeds, M. H. Wright, and P. E. Wright, “Convergence properties of the Nelder-Mead simplex method in low dimensions,” SIAM J. Optim., vol. 9, no. 1, pp. 112-147, 1998). As an alternative, for instance the Broyden-Fletcher-Goldfarb-Shanno method (C. G. Broyden, “The convergence of a class of double-rank minimization algorithms 1. General considerations,” IMA J. Appl. Math. (Institute Math. Its Appl., vol. 6, no. 1, pp. 76-90, 1970), the Davidon-Fletcher-Powell algorithm (W. C. Davidon, “Variable metric method for minimization,” SIAM Journal on Optimization, vol. 1, no. 1. pp. 1-17, 1991) or so-called Trust Region approaches (J. J. Moré and D. C. Sorensen, “Computing a Trust Region Step,” SIAM Journal on Scientific and Statistical Computing, vol. 4, no. 3. pp. 553-572, 1983) can be employed.

Assuming that the originally assumed coarse georeferencing is close to the optimized georeferencing, the mentioned methods increasingly converge to the correct solution. Assuming ideal image data without error and noise, in the ideal case with correct georeferencing both data sets can obtain the same image so that the error is zero. In the case of infrared sensors, for example, this can also be explicitly justified physically by energy conservation (assuming that the observation angles do not deviate too much from each other and that the recordings were made within a short period of time). In real application scenarios, a residual difference will normally remain. In other spectral ranges, it may be advantageous to first carry out appropriate normalizations to support a comparison of the physical measurement parameters of both platforms.

As described, the calibrations of the data sets can be adapted to each other. However, the calibration of one data set can also have a homogeneous offset from the calibration of the other data set. This leads to a homogeneous offset over the entire difference image. If the deviations are distributed symmetrically around zero, this offset becomes zero and a minimum error can be achieved even if the calibration of the data sets are not matched to each other.

Various metrics can be used to evaluate the difference image. The method according to the invention works independently of the metric. In the same way, there are many possibilities for upsampling. A possible offset of measured values does not necessarily have to be calculated out, but can be calculated out in various ways. For example, when using a line scan camera (pushbroom or whiskbroom scanner), different time stamps of the pixels can be combined and weighted differently according to time. The point spread function of the sensors could also be used to introduce a different weighting of the pixels in the image registration.

In some cases, it is also possible for data in different spectral ranges to be used for the data sets if the corresponding characteristic can be interpolated. If, for example, data is available in the infrared range whose spectrum only partially overlaps or does not overlap at all with the other data set, data sets in the required spectral range can be simulated via physical modelling using known laws such as Planck's law of radiation.

Advantageously, the remote sensing platform can be a satellite, an unmanned aerial vehicle or a drone.

Compared to existing methods, the solution offers the advantage of being able to access high-quality georeferencing from large platforms without the need to have its own camera in the visible area on board.

Further advantages are:
Reduction of volume, mass and energy requirements of satellites and spacecraft that need georeferencing but do not have the corresponding imaging hardware on board.
This reduces the costs for start-up and operation.
For satellites that have their own georeferencing, the invention can serve as an important test of the same. In addition, by combining different georeferencing sources, the accuracy of the overall georeferencing can be increased.

Four application scenarios for the approach of the invention will be mentioned by way of example:
1. Hardware on board of satellites that do not take images in the visible wavelength range through cooperative georeferencing is saved.
2. On-board georeferencing through the use of cooperative georeferencing is verified and validated.
3. The accuracy of on-board georeferencing through the additional use of cooperative georeferencing is enhanced.
4. Cooperative georeferencing to increase the redundancy of on-board systems is employed.

An important field of application is the reduction of requirements for small and microsatellites.

The invention will be explained by way of example with reference to some figures. The same reference numerals here designate the same or corresponding features. The features described in the examples can also be realized independently of the corresponding example and can be combined between the examples.

### DESCRIPTION OF DRAWINGS

In the drawings:

FIG. 1 shows a remote sensing data set and a reference data set with different resolution

FIG. 2 shows a remote sensing data set, a difference image and with adjusted resolution, and

FIG. 3 shows reference images between the remote sensing data and the reference data.

### DETAILED DESCRIPTION OF INVENTION

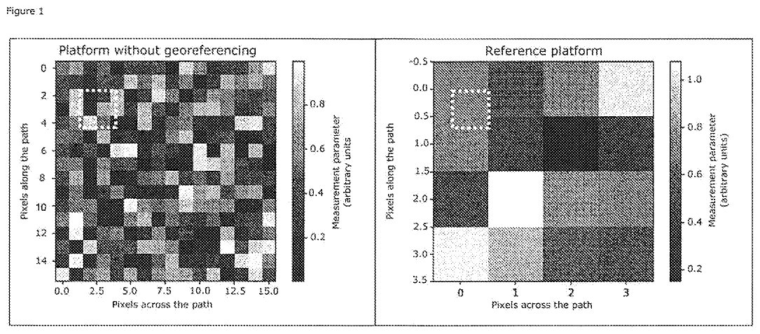

FIG. 1 shows a remote sensing data set on the left partial image, which is shown here as an example matrix with a large number of pixels. Each pixel includes a measured value, which is represented here by a grey scale. The remote sensing data set shown depicts a visual range of the Earth's surface, with pixels plotted along the path of the remote sensing platform over the Earth's surface in the vertical direction and pixels across the path on the horizontal axis. The remote sensing data in the left partial image do not yet have georeferencing.

The right partial image of FIG. 1 shows a reference data set whose georeferencing is known. The data of the reference data set are also plotted as pixels in the direction along the path and across the path. Again, each pixel includes a value of the measurement parameter, which can advantageously be the same measurement parameter as in the left partial image. The spatial resolution of the reference data set in the right image is lower than that of the remote sensing data set in the left image, so that the pixels here represent a larger portion of the Earth's surface. The object of the method according to the invention is to infer the georeferencing of the remote sensing data set from the georeferencing of the reference data set.

The reference data set shown in the right partial image was selected so that the portion of the earth's surface depicted by the reference data set overlaps with the visual range of the remote sensing data set, at least partially. The dashed region shows the sum of the pixels in the image of the remote sensing data that overlap geographically with the dashed pixel of the reference platform.

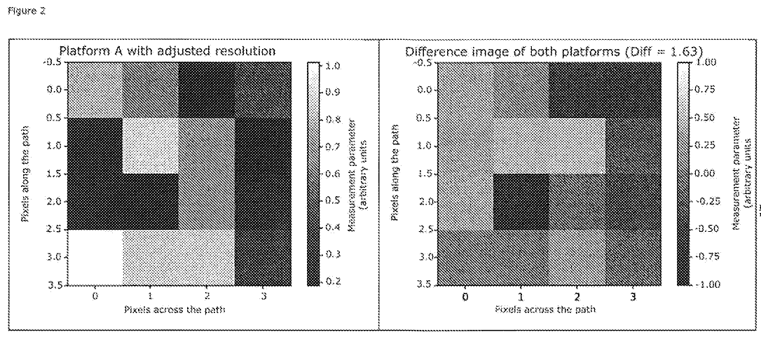

FIG. 2 in the left partial image shows the remote sensing data with a resolution that has been adjusted to the resolution of the reference data set. In the case shown, the resolution of the reference data was reduced for this purpose. Such interpolation can be done, for example, by simple weighted averaging or other known methods. It is assumed that for the currently assumed georeferencing, all pixels of the remote sensing data set that have an areal ratio in a geographically overlapping pixel of the reference data set are included in the interpolation (shown as a dashed square in FIG. 1 as an example for a pixel of the reference platform).

FIG. 2 in the right partial image shows a difference image obtained by subtracting the values of the pixels of the remote sensing data set from the values of corresponding pixels of the reference data set after adapting the resolution, wherein corresponding pixels are those that have the same position. A value can be calculated from the right partial image, for example as Diff=√(Σ_ᵢ (I_{A,i}−I_{Ref,i})²), wherein I_{A,i} is the value of the pixel at position i of the remote sensing data set and I_{Ref,i} is the value of the pixel at position i of the reference data set. In the example shown, this value can be Diff=1.63, for example.

Morphology operations can now be systematically applied to the remote sensing data set and in turn the difference image can be calculated. The steps of comparing and applying morphology operations are repeated until a termination condition arises, which is that the remote sensing data set and the reference data set differ by less than a predefined threshold. For this purpose, for example, the value Diff as defined above can be compared to threshold value. Morphology operations, for example, can be translation, rotation and/or perspective distortion of the image. Instead of the described value Diff, a cross-correlation or another metric describing the difference image can also be used. This value can be fed back to an optimization unit so that the value can be optimized iteratively, for example until a value of Diff=0 results. To this end, for example, changing of the input parameters can be carried out.

In some cases, the difference can depend very strongly on the relative pixel position and can fluctuate in the sub-pixel range, as will be shown in the following one-dimensional example: An IR data set is to be georeferenced, which includes a cooling tower of a power plant, which is about 1 pixel in size (in the reference data set) and surrounded by water. This can be exacerbated by the fact that under certain circumstances there may be no certainty in the absolute calibration, so that in such cases the absolute temperature values that would result from the IR data cannot be assumed to be accurate. If there is now an error of half a pixel in the original georeferencing estimate (after scaling the pixel size to the reference data set), half of the warm tower is located in a pixel area whose other half contains water. Thus, the tower's heat signal is drastically reduced and the expected high temperature value of the tower is not found. If the grid now moves through corresponding morphology transformations, in this case a pure translation, the signature of the cooling tower appears increasingly stronger until only a single pixel encompasses the tower. This example is also intended to illustrate that at coarse resolution it is not possible to assume fixed features against which to georeference. In many cases, these only result from the adaption of the resolutions. For such situations, the iterative method according to the invention to arrive at a suitable georeferencing is advantageous.

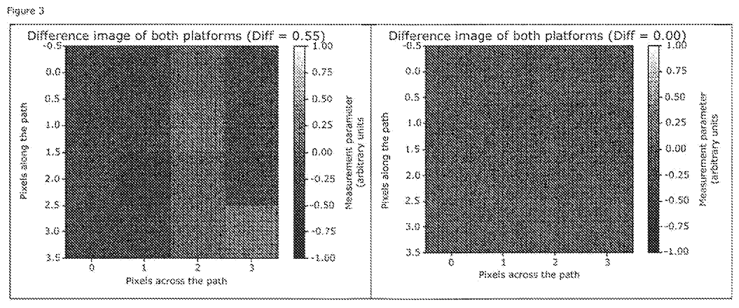

Such an iterative improvement is shown in FIG. 3. Here the improvement was achieved by a piecemeal translation of the remote sensing data set. Targeted optimization can be carried out, for example, using the Nelder-Mead simplex method, the Broyden-Fletcher-Goldfarb-Shanno method, the Davidon-Fletcher-Powell algorithm or using trust region approaches.

In FIG. 3 the left partial image shows the difference image corresponding to the right partial image in FIG. 2 after some iterations. Here, the value Diff as defined above has been reduced to Diff=0.55. Through further iterations, the value Diff can ideally be optimized to Diff=0, which is shown in the right partial image of FIG. 3.

1. A method for georeferencing remote sensing data of a remote sensing platform,
recording a remote sensing data set by the remote sensing platform which depicts a visual range of earth's surface,
a reference data set with known georeferencing is determined, wherein the reference data set depicts a portion of the earth's surface which overlaps at least partially with a visual range,
during a first adjustment step a remote sensing data set and the reference data set are compared to each other, and
in a second adjustment step, a morphology operation is applied to the remote sensing data set or the reference data set based on the comparison,
repeating the first adjustment step and the second adjustment step until it is determined in the first adjustment step by comparing as a termination condition that the remote sensing data set and the reference data set differ from each other by less than a predefined threshold,
in the event of the termination condition occurring, the georeferencing of the reference data set is set as the georeferencing of the remote sensing data set after application of the at least one executed morphology operation.

2. The method according to claim 1, wherein a spatial resolution of the remote sensing data set and a spatial resolution of the reference data set are brought into correspondence for comparison in the first adjustment step.

3. The method according to claim 2, wherein the resolution of the one of the remote sensing data set and the reference data set having the higher resolution is reduced to the resolution of an other of the remote sensing data set and the reference data set.

4. The method according to claim 2,
wherein the remote sensing data set and the reference data set are values given in pixels of at least one measurement parameter,
wherein for comparison in the first adjustment step a difference data set is created from the remote sensing data set and the reference data set having a number of pixels equal to a number of pixels of a data set with reduced resolution, wherein for amount of all positions of pixels of the difference data set, a pixel with position i of the difference data set has as its value a difference between values of a pixel of the remote sensing data set with the same position i and a pixel of the reference data set with the same position i.

5. The method according to claim 1, wherein the predefined threshold is a threshold value which is compared to value Diff=√(Σ_ᵢ(I_{A,i}−I_{Ref,i})²), wherein I_{A,i} is a value of the pixel at position i of the remote sensing data set and I_{Ref,i} is a value of the pixel at position i of the reference data set.

6. The method according to claim 1, wherein a morphology transformation includes at least one translation, at least one rotation and/or at least one perspective distortion of a corresponding data set.

7. The method according to claim 1, wherein a calibration of the remote sensing data set and a calibration of the reference data set are adapted to each other prior to the first adjustment step.

8. The method according to claim 1, wherein the remote sensing platform is a satellite, an unmanned aerial vehicle or a drone.

9. The method according to claim 1, wherein a preliminary georeferencing of the remote sensing platform is estimated for determination of the reference data set.

10. The method according to claim 1, wherein the remote sensing data set and the reference data set are recorded in a same spectral range.

11. The method according to claim 1, wherein the remote sensing data set and/or the reference data set are recorded in a infrared range.

12. The method according to claim 1, wherein the reference data set is recorded at a time interval from the remote sensing data of at most 24 hours.
